(19) United States
(12) Patent Application Publication
(10) Pub. No.: US 2024/0335779 A1
(43) Pub. Date: Oct. 10, 2024

(54) FILTER MEDIUM COMPRISING A MELT-BLOWN NONWOVEN, AND ITS USE

(71) Applicant: Neenah Gessner GmbH, Bruckmühl (DE)

(72) Inventor: Simon GRAVOT, München (DE)

(21) Appl. No.: 18/579,278

(22) PCT Filed: Jul. 5, 2022
(86) PCT No.: PCT/EP2022/068606

§ 371 Date: Jan. 12, 2024

(30) Foreign Application Priority Data
Jul. 14, 2021 (DE) 10-2021-207504.5

(51) Int. Cl. B01D 39/16

(52) U.S. Cl. CPC B01D 39/1607; B01D 2221/02; B01D 2221/10; B01D 2239/0618; B01D 2239/0622; B01D 2239/1233

(57) ABSTRACT

Provided herein is a filter medium comprising a first nonwoven melt-blown layer, the meltblown nonwoven comprising a) at least one styrenic thermoplastic elastomer and b) at least one polyolefin. Also provided herein is the use of the filter medium for coffee filters, compressed air filters and face masks.

### CROSS-REFERENCE TO RELATED APPLICATIONS

This application is a national stage application, filed under 35 U.S.C. § 371, of International Patent Application No. PCT/EP2022/068606 filed Jul. 5, 2022, which claims the benefit of German Patent Application No. DE 10 2021 207 504.5 filed Jul. 14, 2022, the entire disclosures of which are incorporated herein by reference for all purposes.

### TECHNICAL FIELD

This relates to a filter medium comprising a first ply of a meltblown nonwoven, wherein the meltblown nonwoven comprises a) at least one styrenic thermoplastic elastomer and b) at least one polyolefin, and to the use of said filter medium for coffee filters, especially filters for coffee capsules, compressed air filters or facemasks.

### BACKGROUND

In order to remove solid impurities, for example dust particles, from liquids and gases, there are essentially two different types of filter media.

The first type is depth filter media, which are constructed such that they able to absorb and store a maximum amount of dust before becoming blocked. Such filter media ideally have an asymmetric structure, meaning that the pore and fiber diameters become ever smaller viewed in flow direction. The effect of this is that the large dust particles are preferentially deposited and stored in the uppermost layer of the depth filter medium, while the small dust particles penetrate deeper before they too are deposited. This distribution of the dust particles throughout the depth of the filter medium allows a comparatively large amount of dust to be stored before the flow of liquid or gas through the stored dust particles is so greatly hindered that the filter medium becomes blocked. These filters cannot be cleaned and must be deinstalled and disposed of after attainment of a defined pressure differential.

The second type is surface filter media. In the case of these filter media, the first filtration layer in flow direction has the smallest pore and fiber diameters. The next layer usually has more open pores and has thicker fibers. It serves mainly as carrier for the first filtration layer and imparts the required mechanical strength and stiffness to the overall filter medium. All dust particles, no matter whether they are large or small, are ideally deposited on the first layer and do not penetrate into the filter medium.

As a result, a cake of dust is formed with time on the surface of the filter medium, which hinders the flow of liquid or gas to an evengreater degree. Since the dust cake sits quite loosely on the surface of the filter medium, it can also be cleaned off again comparatively easily. The cleaning is ideally effected either by tapping, shaking, washing, a pressure pulse or back-flushing. In the case of back-flushing and in the case of a pressure pulse, the filter medium is briefly subjected to clean liquid or clean gas counter to the original flow direction. This detaches the dust cake from the surface of the filter medium, and the filter medium thus cleaned is ready for the next filtration cycle. In the case of back-flushing, this is effected over a prolonged period of time with a comparatively low flow rate of the cleaning fluid, whereas, in the case of a pressure pulse, the cleaning fluid is applied in a short, powerful pulse.

Filter media for surface filtration are either of single-ply or multi-ply construction. Single-ply surface filter media are, for example, filter papers that have smaller pores on the inflow side than on the outflow side, or single-sidedly densified needlefelts or spunbonded nonwovens. A single-sidedly densified spunbonded nonwoven is described by way of example in document DE 10 039 245 A1. The single-ply filter media, in spite of single-sided surface densification, still have comparatively large pores on the densified side and are suitable only for quite coarse dusts. Finer dust particles penetrate deep into the filter medium and cannot be cleaned off again. As a result, the filter medium or filter element comprising the filter medium becomes blocked after a comparatively short time and has to be exchanged.

In order to assess the performance of a filter, for example, the service life has been introduced as a criterion. The service life or else lifetime of a filter element is the time that elapses from the time of first use of the filter element until attainment of a defined maximum pressure differential. The greater the filtration area of the filter element and the better the dust storage capacity of the filter element on account of its surface characteristics, the longer the service life.

In order to deposit fine dusts, for example color powders, ground resins or cement, filter media having at least two-ply construction are used. Either a membrane, a nanofiber layer or a meltblown layer is applied as filtration ply to a carrier having a high mechanical strength and stiffness. The filtration ply, viewed in flow direction, is the first ply.

One example of a filter medium with a meltblown layer is described in German published specification DE 44 431 58 A1. The advantage of these filter media is their comparatively low cost. A disadvantage here too, however, is that the mechanical strength of the meltblown layer is not very high.

The use of meltblown nonwovens as filter media has long been known. The meltblown process is described in detail, for example, in A. van Wente, “Superfine Thermoplastic Fibers”, Industrial Engineering Chemistry, vol. 48, pp. 1342-1346. By this process, it is possible to produce essentially continuous fibers having a diameter of 0.3-15 μm. The lower the fiber diameter and the greater the density of the fibers with respect to one another, the better the suitability of the meltblown nonwoven for separation of fine dusts from gases and liquids. Unfortunately, however, the mechanical strength of the fibers also falls with the fiber diameter. Whenever the meltblown nonwoven thus produced is subjected to mechanical stress, for example when a finger is rubbed across the surface or in the folding of the filter medium during the later filter element production, some fibers will break and dendrites will be formed. Dendrites mean torn meltblown fibers of different length that protrude from the surface of the meltblown nonwoven at an angle of 10° to 90°. Since the filter medium is usually folded in the production of a filter element, the dendrites will project into the otherwise clear space on the inflow side. The protrusion of the dendrites from the surface of the meltblown nonwoven is increased when the meltblown nonwoven can be electrostatically charged. Filter elements with such filter media made from meltblown nonwovens tend to become blocked even after a short time, with the consequence that the filter element has to be exchanged.

As described in DE 44 431 58 A1 and DE 10 039 245 A1, it is possible by thermal surface densification by means of a calender to improve mechanical strength and surface smoothness. But surface densification that distinctly increases the mechanical strength of the meltblown nonwoven simultaneously has an adverse effect on porosity and air permeability. Moreover, thermal densification constitutes an additional process step. DE 44 431 58 A1 also discloses that the meltblown nonwoven, alone or together with a carrier, can be consolidated with a binder in order to increase abrasion resistance and scour resistance. But this method again has an adverse effect on the air permeability of the filter medium and constitutes a further, costly method step.

Different methods are familiar to the person skilled in the art for generation of corresponding filter media. The meltblown and spunbonding methods in particular are suitable for producing nonwovens from a wide variety of different polymers.

By correct choice of the raw material, it is possible to achieve nonwovens having various properties. For instance, elastic nonwovens inter alia may be present, which have been used for some time for different applications. The most commonly used polymer for such nonwovens is thermoplastic polyurethane, which has many advantages such as good stability and adjustable elasticity. In addition, there have already been publications on melt-spun nonwovens of TPA (thermoplastic polyamide elastomer) and TPC (thermoplastic copolyester elastomer).

A disadvantage of meltblown nonwovens of TPU (thermoplastic polyurethane) is that they are of limited suitability for the foods sector. Chain degradation and hydrolysis can give rise to primary aromatic amines, some of which are carcinogenic to humans.

A further disadvantage of meltblown nonwovens of TPU is that these nonwovens cannot be electrostatically charged. For various applications, for example facemasks, however, charged nonwovens are advantageous.

For those reasons, it was a desirable objective to provide an improved filter medium that at least partly remedies the disadvantages known from the prior art.

### SUMMARY

The present objective is achieved by providing a filter medium comprising a first ply of a meltblown nonwoven, wherein the meltblown nonwoven comprises
a) at least one styrenic thermoplastic elastomer and
b) at least one polyolefin.

“Meltblown nonwoven” here means all nonwovens that can be produced by the meltblown method known to the person skilled in the art for production of filter media, i.e. a method in which a molten polymer is extruded into a hot gas stream at high speed, such that the molten polymer is converted to fibers.

The term “filter medium” here refers to any device that can be used for the process of filtration, i.e. the mechanical or physical method of separating one substance from another, such as solids, liquids and gases, with the aid of an intervening filter medium.

The layer thickness of the first, second and third plies (layers) and thickness of the overall filter medium is according to DIN EN ISO 9073-2:1997-02 under a pressure of 0.5 kPa.

Thermoplastic elastomers (TPE) are polymers or polymer mixtures that have comparable behavior to the conventional elastomers at room temperature, but can be plastically deformed with supply of heat and hence show thermoplastic characteristics. Thermoplastic elastomers regularly contain a hard phase and a soft phase, where the hard phase is responsible for thermoplastic processibility and the soft phase for elastic character.

Thermoplastic styrene elastomers (TPS) are the most rubberlike among the TPEs and are notable for excellent flexibility and elasticity. With polystyrene (PS) as hard segments, the product variants are classified on the basis of the difference in the soft segment materials into SBS (S: styrene, B: butadiene), SIS (I: isoprene) and hydrogenated variants thereof, SEBS (E: ethylene, B: butylene) and SEPS (P: propylene). SEBS and SEPS have excellent heat stability and weathering stability. Because of their good equilibrium between formability, flexibility and mechanical strength, they are used in a multitude of applications.

In block copolymers, for example styrene block copolymers (SBC), there are hard and soft phases within one molecule.

### DETAILED DESCRIPTION OF THE EMBODIMENTS

Provided herein is a meltblown nonwoven, preferably an elastic meltblown nonwoven based on TPS, i.e. a thermoplastic elastomer based on styrene block copolymers, which can be processed in a mixture with a polyolefin. The olefin structure of these polymers does not permit release of aromatic amines and, because of its low tendency to hydrolysis, is additionally of good suitability for use in food applications.

Preferred styrene block copolymers are selected from the group consisting of styrene-ethylene-butylene-styrene (SEBS), styrene-ethylene-propylene-styrene (SEPS), styrene-ethylene-ethylene-propylene-styrene (SEEPS), styrene- isobutylene-styrene (SIBS), styrene-butadiene-styrene (SBS), styrene-isoprene- styrene (SIS) and mixtures thereof. Particular preference is given to SEBS, SIS and SBS.

Thermoplastic elastomers, which are referred to as TPS, are, for example, mixtures based on SBS or SEBS. In fact, the words SBS or SEBS are frequently used to describe these components when they are in fact raw materials. The description of components as SBS or SEBS enables knowledge of the general performance level and properties of the components.

SBS is based on biphasic block copolymers having hard and soft segments. The styrene end blocks ensure the thermoplastic properties, and the butadiene middle blocks the elastomeric properties.

When it is hydrogenated, SBS becomes SEBS, since the elimination of the C=C bonds in the butadiene component creates ethylene and butylenes in the middle block. SEBS is notable for improved heat stability, mechanical properties and chemical stability. SEBS-based components adhere to technical thermoplastics; in the case of adhesion to PP, it is possible to use either SBS or SEBS.

SEPS, styrene-ethylene-propylene-styrene, also known as styrene- ethylene/propylene-styrene (SEPS), is a thermoplastic elastomer (TPE) that behaves like rubber without being vulcanized. SEPS is very flexible, has excellent thermal stability and UV stability, and is easy to process. It is produced by partial selective hydrogenation of styrene-isoprene-styrene (SIS), which improves thermal stability, weathering resistance and oil resistance, and makes SEPS sterilizable by steam. However, hydrogenation also reduces mechanical efficiency and increases the costs of the polymer. SEPS elastomers are often mixed with other polymers in order to improve their performance.

Particularly suitable styrene block copolymers are triblock copolymers of styrene/conjugated diene/styrene, hydrogenated derivatives thereof or mixtures thereof. The conjugated diene is typically selected from butadiene and isoprene.

Styrene block copolymers that are suitable in accordance with the description herein preferably contain at least 25% by weight of styrene, more preferably 25- 65% by weight of styrene and especially preferably 35% to 60% by weight, in particular 40% to 60% by weight, of styrene, and up to 75% by weight, more preferably 75% to 35% by weight and especially preferably 65% to 40% by weight, in particular 60% to 40% by weight, of conjugated diene. A polystyrene block copolymer having a high styrene content of 57% by weight is available, for example, under the Kraton™ A1535H trade name.

Polyolefins preferably comprise thermoplastic crystalline polyolefin homopolymers and copolymers. Suitable polyolefins are homopolymers and copolymers of olefins having preferably 2 to 8 carbon atoms, for example ethylene, propylene, 1-butene, isobutylene, 1-pentene, 1-hexene, 1-octene, 3-methyl-1-pentene, 4-methyl-1- pentene, 5-methyl-1-hexene, and copolymers of such olefins with (meth) acrylates and/or vinyl acetates.

The polyolefin present in the meltblown nonwoven is more preferably a thermoplastic polyolefin.

Thermoplastic polyolefins may be used alone or as mixtures. Preferred thermoplastic polyolefins are polypropylenes (PP) and polyethylenes (PE), where polypropylenes mean both homopolymers and copolymers of propylene with about 1% to about 20% by weight of other olefins such as ethylene or a-olefins having 4- 16 carbon atoms and mixtures thereof. The polypropylene may be highly crystalline, isotactic or syndiotactic polypropylene.

The polyolefin is more preferably either polypropylene or polyethylene.

Preference is given to a filter medium wherein the first ply of a meltblown nonwoven comprises
a) 1-99% by weight, preferably 20-80% by weight, more preferably 21-80% by weight, of at least one styrenic thermoplastic elastomer and
b) 1-99% by weight, preferably 20-80% by weight, more preferably 20-79% by weight, of at least one polyolefin.

Particular preference is given to a filter medium wherein the first ply of a meltblown nonwoven consists of
a) 1-99% by weight, preferably 20-80% by weight, more preferably 21-80% by weight, of at least one styrenic thermoplastic elastomer and
b) 1-99% by weight, preferably 20-80% by weight, more preferably 20-79% by weight, of at least one polyolefin.

Preference is given to a filter medium wherein the first ply of a meltblown nonwoven comprises
a) 1-99% by weight, preferably 20-80% by weight, more preferably 21-80% by weight, of at least one styrenic thermoplastic elastomer and
b) 1-99% by weight, preferably 20-80% by weight, more preferably 20-79% by weight, of polypropylene.

Particular preference is given to a filter medium wherein the first ply of a meltblown nonwoven consists of
a) 1-99% by weight, preferably 20-80% by weight, more preferably 21-80% by weight, of at least one styrenic thermoplastic elastomer and
b) 1-99% by weight, preferably 20-80% by weight, more preferably 20-79% by weight, of polypropylene.

The ratio of styrenic thermoplastic elastomer to polyolefin is preferably 1/99 to 99/1, more preferably 10/90 to 90/10, more preferably 10/90 to 80/20, more preferably 20/80 to 80/20, more preferably 40/60 to 80/20, especially preferably 60/40 to 70/30. The higher the proportion of styrenic thermoplastic elastomer, the softer and more elastic the meltblown nonwoven; the higher the proportion of polyolefin, the harder the meltblown nonwoven and the easier it is to electrostatically charge the meltblown nonwoven. The person skilled in the art can thus correspondingly adjust the ratio of styrenic thermoplastic elastomer to polyolefin for the desired use.

The styrenic thermoplastic elastomers used in accordance with the description and/or polyolefins used may comprise further, especially non-hygroscopic, additives. Examples of such additives are fillers, for example inorganic fillers such as calcium carbonate, clays, silicon dioxide, talc and titanium dioxide; adhesion promoters; biocides; antifogging agents; binders, blowing agents and foaming agents; dispersants; fire and flame retardants and smoke suppressants; impact modifiers; crosslinking agents; lubricants; mica; pigments, colorants and dyes; additional processing auxiliaries; separating agents; silanes, titanates and zirconates; lubricants and antiblocking agents; stabilizers; stearates; UV absorbers; viscosity regulators; waxes; and combinations thereof.

The meltblown nonwoven as decribed herein preferably comprises fibers having an average diameter (d) of less than 15 um, more preferably of 1 μm≤d <10 μm, and more preferably of 1 μm≤d≤8 μm. For use in facemasks, an average diameter (d) of 1 μm≤d<4 μm is particularly suitable. As can be inferred from this, a meltblown nonwoven having the defined fiber diameter is capable of meeting the standards for type I, II and IIR facemasks according to DIN EN 14683:2019-10 or FFP1, FFP2 and FFP3 according to DIN EN 149:2009-08, which enables use of the filtration layer of the present description in facemasks.

In the present description, a distinction is drawn between “average diameter” and “diameter”. This difference is important because the average diameter does not give any information as to the amount of fine fibers having a particular diameter.

The first ply of a meltblown nonwoven preferably has a thickness of more than 0.20 mm according to DIN EN ISO 9073-2:1997-02 under a pressure of 0.5 kPa. More preferably, the thickness of the nonwoven ply is 0.30 to 1.20 mm and in particular 0.40-1.00 mm.

The mass per unit area of the first ply of a meltblown nonwoven is preferably between 15 g/m² and 400 g/m² and more preferably between 20 g/m² and 300 g/m². Especially preferred is the range between 25 and 200 g/m².

The air permeability of the first ply of a meltblown nonwoven is preferably 50-2000 I/m2s, more preferably 200-1500 l/m²s, at 200 Pa. For use in facemasks, the range between 100 and 700 l/m²s is particularly suitable. For use in compressed air filters, an air permeability between 50 and 500 l/m²s is particularly suitable. For use in coffee filters and filters for coffee capsules, an air permeability between 700 and 1500 l/m²s is particularly suitable.

The tensile strength of the first ply of a meltblown nonwoven in machine direction (MD) is preferably 5-100 N/5 cm.

The tensile strength of the first ply of a meltblown nonwoven in cross direction (CD) is preferably 5-80 N/5 cm.

The elongation at break of the first ply of a meltblown nonwoven in machine direction (MD) is preferably 100-500%; especially preferred is the range of 150- 400% and the range of 300-500%.

The elongation at break of the first ply of a meltblown nonwoven in cross direction (CD) is preferably 100-500%; especially preferred is the range of 150-400% and the range of 300-500%.

Resistance to the penetration of water at 60 bar/min is preferably 10-60 mbar, more preferably 15-50 mbar.

The meltblown nonwoven is preferably produced as a sole ply; combination with a second ply of a nonwoven or a different textile product or textile is possible. This second ply preferably has a thickness of less than 0.50 mm to DIN EN ISO 9073- 2:1997-02 under a pressure of 0.5 kPa. The thickness of the second ply is more preferably 0.10 to 0.40 mm and especially 0.10-0.35 mm.

The second ply consists of a nonwoven or textile, preference being given to using a spunbonded nonwoven or carded nonwoven consisting of polypropylene, polyester or an elastic thermoplastic polymer.

“Nonwovens” are fabrics that have been manufactured from fibers and consolidated in different ways. Nonwovens are produced from fibers without any restriction, but not necessarily with textile fibers.

“Textile products” or “textiles” are linear, two-dimensional or three-dimensional structures that are formed from textile raw materials (natural fibers or synthetic fibers) and nontextile raw materials. By way of distinction from nonwovens, the term “textile” is used in this description for two-dimensional materials, the main constituents of which are textile fibers, i.e. fibers that can be processed in textile manufacturing methods, and in particular are spinnable and are processed in the form of yarns. Since textile fibers are spinnable, the main difference between textile products and nonwovens in the sense of weave directions is that textile substrates therefore also consist of unidirectional weaves in which all the reinforcing threads are likewise oriented in one direction.

The mass per unit area of the second ply is preferably 10 g/m²-120 g/m², more preferably from 12 g/m² to 90 g/m²

The second ply can be produced using any known method. Preference is given to using a nonwoven that may have been consolidated chemically and/or thermally and/or mechanically.

The second ply has preferably been formed from a polymer selected from the group consisting of polypropylene, polyester or an elastic, thermoplastic polymer. The second ply is preferably formed from a polymer selected from the group consisting of polyethylene terephthalate (PET), polybutylene terephthalate (PBT), polycarbonate (PC), polyamide (PA), polyphenylene sulfide (PPS), polyolefin (PO), thermoplastic polyurethane (TPU), thermoplastic copolyester (TPC), thermoplastic styrene block copolymers (TPS) or mixtures thereof.

The second ply has preferably been formed from a polymer comprising or consisting of a polyamide (PA). At least a portion of the polyamide (PA) is preferably thermoplastic polyamide (TPA). The polyamide (PA) is preferably a thermoplastic polyamide (TPA). The polyamide (PA) is preferably a thermoplastic polyamide elastomer.

The second ply is preferably formed from a polymer comprising or consisting of a thermoplastic copolyester (TPC). The thermoplastic copolyester (TPC) is preferably a thermoplastic copolyester elastomer.

The second ply is preferably formed from a polymer comprising or consisting of a thermoplastic styrene block copolymer (TPS). The thermoplastic styrene block copolymer (TPS) is preferably a thermoplastic styrene elastomer.

“Thermoplastic” is understood here to mean the behavior of polymers of being readily deformable within a particular temperature range, this operation being reversible.

“Elastomer” or “elastic polymer” is understood here to mean a dimensionally stable polymer which is elastically deformable, for example under tensile and compressive stress, and has a glass transition point below the use temperature.

More preferably, the second ply may comprise or consist of a nonwoven or a textile of polypropylene, polyester or an elastic, thermoplastic polymer.

More preferably, the second ply may comprise or consist of a spunbonded nonwoven of polypropylene, polyester or an elastic, thermoplastic polymer. Most preferably, the second ply is a spunbonded nonwoven consisting of polypropylene, polyester or an elastic, thermoplastic polymer. Most preferably, the second ply may comprise or consist of a spunbonded nonwoven composed of polypropylene or polyester.

More preferably, the second ply may comprise or consist of a carded nonwoven composed of polypropylene, polyester or an elastic, thermoplastic polymer. Most preferably, the second ply is a carded nonwoven consisting of polypropylene, polyester or an elastic, thermoplastic polymer. Most preferably, the second ply may comprise or consist of a carded nonwoven composed of polypropylene or polyester.

The first ply and the second ply are preferably identical, i.e. both the first ply and the second ply preferably comprise a meltblown nonwoven comprising at least one at least one styrenic thermoplastic elastomer and at least one polyolefin. More preferably, both in the first ply and in the second ply, the styrenic thermoplastic elastomer is selected from the group consisting of styrene-ethylene-butylene- styrene (SEBS), styrene-ethylene-propylene-styrene (SEPS), styrene-ethylene- ethylene-propylene-styrene (SEEPS), styrene-isobutylene-styrene (SIBS), styrene-butadiene-styrene (SBS), styrene-isoprene-styrene (SIS) and mixtures thereof, and the polyolefin is polypropylene or polyethylene.

Apart from the first ply composed of a meltblown nonwoven and the second ply, the filter medium may additionally comprise a third ply, preferably as protective ply. The filter medium preferably comprises a third ply composed of a nonwoven or textile, where the first, second and third plies are arranged one on top of another.

Polymers suitable for the third ply are polyethylene terephthalate (PET), polybutylene terephthalate (PBT), polycarbonate (PC), polyamide (PA), polyphenylene sulfide (PPS), polyolefin (PO), thermoplastic polyurethane (TPU), thermoplastic copolyester (TPC), thermoplastic styrene block copolymers (TPS) or mixtures thereof.

The third ply is preferably formed from a polymer comprising or consisting of a polyamide (PA). Preferably, at least a portion of the polyamide (PA) is thermoplastic polyamide (TPA). The polyamide (PA) is preferably a thermoplastic polyamide (TPA). The polyamide (PA) is preferably a thermoplastic polyamide elastomer.

The third ply is preferably formed from a polymer comprising or consisting of a thermoplastic copolyester (TPC). The thermoplastic copolyester (TPC) is preferably a thermoplastic copolyester elastomer.

The third ply is preferably formed from a polymer comprising or consisting of a thermoplastic styrene block copolymer (TPS). The thermoplastic styrene block copolymer (TPS) is preferably a thermoplastic styrene elastomer.

The third ply may be produced either by a nonwoven method or by a textile method. Preference is given to production by the spunbonding method.

More preferably, the third ply may comprise or consist of a nonwoven or a textile composed of polypropylene or polyester.

Most preferably, the third ply may comprise or consist of a spunbonded nonwoven composed of polypropylene or polyester.

The first ply, the second ply and the third ply are preferably identical, i.e. the first ply, the second ply and the third ply preferably all comprise a meltblown nonwoven comprising at least one styrenic thermoplastic elastomer and at least one polyolefin. More preferably, in all of the first ply, the second ply and the third ply, the styrenic thermoplastic elastomer is selected from the group consisting of styrene-ethylene-butylene-styrene (SEBS), styrene-ethylene-propylene-styrene (SEPS), styrene-ethylene-ethylene-propylene-styrene (SEEPS), styrene- isobutylene-styrene (SIBS), styrene-butadiene-styrene (SBS), styrene-isoprene- styrene (SIS) and mixtures thereof, and the polyolefin is polypropylene or polyethylene.

The average diameter (d) of the fibers in the third ply is preferably 2 μm≤d≤50 μm and more preferably 5 μm≤d≤40 μm and very preferably 10 μm≤d≤30 μm.

The third ply preferably has a mass per unit area of 8 g/m²-100 g/m², more preferably of 10 g/m² to 50 g/m².

For production of the filter medium, the first ply composed of a meltblown nonwoven may be bonded to the second ply composed of a nonwoven or textile. For this purpose, it is possible to use any method known to the person skilled in the art, for example needling methods, waterjet needling methods, thermal methods (i.e. calender consolidation and ultrasound consolidation) and chemical methods (i.e. consolidation by means of adhesives).

The first ply composed of a meltblown nonwoven is preferably bonded to the second ply composed of a nonwoven or textile by spot calendering.

The third ply may preferably likewise be bonded to the second ply by spot calendering or laid out without bonding.

In addition, the first ply composed of a meltblown nonwoven may be a charged meltblown nonwoven. Electrostatic charging of the fibers can increase filtration efficiency. This is advantageous especially for the use of the filter medium as facemask. Corona charging, hydrocharging or charging with polar liquid such as water and triboelectric charging or combinations thereof are known charging methods. Corona charging is the most commonly used method for the mass production of charged filter media.

The term “corona charging” relates here to a method of producing a charged nonwoven in which fibers of a nonconductive polymer material are exposed to an AC and/or DC corona charging apparatus, such that the fibers are charged.

The term “water charging”, also called “hydrocharging”, relates here to a method of producing a charged nonwoven in which fibers are exposed to a water mist, such that charges are applied to the fibers. The treatment can be conducted either directly after the formation of the fibers or after a nonwoven has been formed from the fibers.

The possibility of electrostatically charging the first ply of a meltblown nonwoven in order thus to obtain a filter medium comprising a first ply of a charged meltblown nonwoven, as well as good suitability for the foods sector, is a further advantage over meltblown nonwovens made from TPU, which cannot be electrostatically charged. A filter medium comprising a first ply of a charged meltblown nonwoven according to the description is thus particularly suitable for use in facemasks.

An additional advantage of the first ply of a meltblown nonwoven is the water- repellent properties, which is expressed by a high water penetration resistance. The resistance to the penetration of water of the first ply composed of a meltblown nonwoven at 60 mbar/min is preferably in the region of 15-100 mbar, more preferably 20-60 mbar.

The filter medium is preferably used for coffee filters, especially for filters for coffee capsules. In the case of use as a coffee filter, the filter medium is preferably a single-ply filter medium that comprises solely the first ply composed of a meltblown nonwoven.

The filter medium is preferably used for compressed air filters. In the case of use as compressed air filter, the filter medium is preferably a multi-ply filter medium, especially a two-or three-ply filter medium comprising, as well as the first ply of a meltblown nonwoven, the second ply of a nonwoven or textile and optionally the third ply of a nonwoven or textile.

The filter medium is preferably used for facemasks. In the case of use as facemasks, the filter medium is preferably a multi-ply filter medium, especially a two-or three-ply filter medium comprising, as well as the first ply of a meltblown nonwoven, the second ply of a nonwoven or textile and optionally the third ply of a nonwoven or textile. In addition, the first ply, in the case of use for facemasks, is preferably a ply of a charged meltblown nonwoven. The meltblown nonwoven is preferably charged by corona charging or by water charging.

### Test Methods

Mass per unit area according to DIN EN 29073-1:1992-08.

Thickness according to DIN EN ISO 9073-2:1997-02 under a pressure of 0.5 kPa.

Air permeability according to DIN EN ISO 9237:1995-12 with a measurement area of measurement area 20 cm² and pressure differential 200 Pa.

Tensile strength (MD and CD) in accordance with DIN EN 29073-3:1992-08 with a strip width of 50 mm, a clamped length of 100 mm and a speed of 100 mm/min.

Elongation at break (MD and CD) in accordance with DIN EN 29073-3:1992-08 with a strip width of 50 mm, a clamped length of 100 mm and a speed of 100 mm/min.

Resistance to the penetration of water according to DIN EN ISO 811:2018-08 at a rate of 60 mbar/min

Breathing resistance and penetration were measured according to EN143:2007-02 with paraffin oil as test aerosol, an air flow rate of 95 l/min, a sample size of 100 cm2 and a measurement time of 210 sec. Any suitable device can be used, for example a Lorenz facemask testbed.

### Fiber Diameter

i. Principle of measurement

A scanning electron microscope is used to record images in defined magnification. These are analyzed by means of automatic software. Measurement sites that cover crossing points of fibers and hence do not show the fiber diameter are removed manually. Fiber bundles are generally regarded as a fiber.

ii. Equipment

For example, Phenom Fei scanning electron microscope with accompanying Fibermetric V2.1 software. It is possible to use any suitable instrument and any suitable software.

iii. Performance of the test
a. Sputter coating of sample
b. Random imaging by optical image; the site thus found is imaged with 1000-fold modification by SEM.
c. Fiber diameter determination by a one-click method; each fiber must be covered once;
d. Average value and fiber diameter distribution are evaluated by Excel by means of the data obtained by Fibermetric.

At least 100 fibers are evaluated.

Likewise recorded is the percentage of fibers with a diameter of <1.00 μm.
e. Errors/standard deviation

The standard deviation is also quoted.

### EXAMPLES

There follows a description of examples of the filter medium described herein, consisting of a first ply of a meltblown nonwoven.

Polymer: 65% SEBS, 35% PP

| | Example 1 | Example 2 | Example 3 | Example 4 |
|---|---|---|---|---|
| Mass per unit area | 85.1 | 87.6 | 50.4 | 233.5 |
| [g/m²] | | | | |
| Thickness (0.5 kPa) | 0.58 | 0.65 | 0.58 | 0.8 |
| [mm] | | | | |
| Air permeability | 456 | 503 | 1124 | 121.3 |
| (200 Pa) [l/m²s] | | | | |
| Resistance to the | 29.7 | 29.8 | 20.1 | 47.8 |
| penetration of water | | | | |
| (60 mbar/min) | | | | |
| [mbar] | | | | |
| Tensile strength | 15.7 | 18.3 | 9.5 | 52.7 |
| MD*¹ [N/5 cm] | | | | |
| Tensile strength | 13.3 | 15.1 | 8.5 | 42.1 |
| CD*¹ [N/5 cm] | | | | |
| Elongation at break | 206 | 458.9 | 152.5 | 195.0 |
| MD*¹ [%] | | | | |
| Elongation at break | 219.5 | 483.7 | 151.3 | 187.9 |
| CD*¹ [%] | | | | |
| Charging | corona | water | | |
| | | charging | | |
| Average fiber | 7 | 7.5 | 7 | |
| diameter [μm] | | | | |
| In W1 [l/min] 30 Pa *² | 21.7 | 20.4 | | |
| In W2 [l/min] 95 Pa *² | 69.4 | 64.0 | | |
| Out [l/min] 160 Pa *² | 119.1 | 109.2 | | |

*¹100 × 50 mm, 100 mm/min
*² Breathing resistance and penetration to EN143: 2007-02 with paraffin oil as test aerosol

The filter media described in examples 1 and 2 can be used for a facemask.

The filter medium described in example 3 can be used as coffee filter, especially as filter for coffee capsules.

The filter medium described in example 4 can be used for compressed air filters.

1. A filter medium comprising:
a first ply of a meltblown nonwoven, wherein the meltblown nonwoven comprises:
a) at least one styrenic thermoplastic elastomer and
b) at least one polyolefin.

2. The filter medium as claimed in claim 1, wherein the styrenic thermoplastic elastomer is selected from the group consisting of styrene-ethylene-butylene-styrene (SEBS), styrene-ethylene-propylene-styrene (SEPS), styrene-ethylene-ethylene-propylene-styrene (SEEPS), styrene-isobutylene-styrene (SIBS), styrene-butadiene-styrene (SBS), styrene-isoprene-styrene (SIS) and mixtures thereof.

3. The filter medium as claimed in claim 1, wherein the polyolefin is either polypropylene or polyethylene.

4. The filter medium as claimed in claim 1, wherein the meltblown nonwoven comprises fibers having an average diameter (d) of less than 15 μm.

5. The filter medium as claimed in claim 1, wherein the air permeability of the first ply of a meltblown nonwoven is 50-2000 1/m²s.

6. The filter medium as claimed in claim 1, wherein the first ply of a meltblown nonwoven comprises:
a) 1-99% by weight of at least one styrenic thermoplastic elastomer and
b) 1-99% by weight of at least one polyolefin.

7. The filter medium as claimed in claim 1, further comprising
a second ply of a nonwoven or textile.

8. The filter medium as claimed in claim 7, wherein the nonwoven or textile of the second ply is formed from a polymer selected from the group consisting of polyethylene terephthalate (PET), polybutylene terephthalate (PBT), polycarbonate (PC), polyamide (PA), polyphenylene sulfide (PPS), polyolefin (PO), thermoplastic polyurethane (TPU), thermoplastic copolyester (TPC), thermoplastic styrene block copolymers (TPS) or mixtures thereof.

9. The filter medium as claimed in claim 7, further comprising:
HI) a third ply of a nonwoven or textile, where the first, second and third plies are arranged one on top of another.

10. The use of the filter medium as claimed in claim 1 for coffee filters, preferably for filters for coffee capsules.

11. The use of the filter medium as claimed in claim 1 for compressed air filters.

12. The use of the filter medium as claimed in claim 1 for facemasks.
